(19) United States
(12) Patent Application Publication
(10) Pub. No.: US 2007/0019150 A1
(43) Pub. Date: Jan. 25, 2007

(54) Display device with spacers and seals and the method of manufacture thereof

(75) Inventors: Peter Jan Slikkerveer, Eindhoven (NL); Peter Albert Cirkel, Eindhoven (NL); Hendrik Johannes Boudewijn Jagt, Eindhoven (NL); Nicolaas Kooyman, Eindhoven (NL); Petrus Cornelis Paulus Bouten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,240

(22) PCT Filed: Aug. 17, 2004
(86) PCT No.: PCT/IB04/51468

§ 371 Date: Feb. 28, 2006

(30) Foreign Application Priority Data
Sep. 4, 2003 (EP) 03103295.6

(51) Int. Cl. G02F 1/1339

(52) U.S. Cl. 349/156

(57) ABSTRACT

Using lithographic spacers (6) and seals (12) in e.g. LCD a first adhesion of the substrates (2,3) is obtained by incomplete solidifying (both physical or chemical) of the resin used for the spacers and/or the polyimide used for the seal. Final solidifying of the spacers may take place during solidifying of the seal afterwards or simultaneously.

The invention relates to the manufacturing of a (display) device comprising substrates arranged in opposite relation with respect to each other by spacing means (spacers).

The device usually is a display device, in which the electro-optical medium is a liquid crystal display device, but other electro-optical media are not excluded and the invention consequently also relates to e.g. electrophoretic devices or any other (display) device in which spacing means are present.

The invention further relates to a display device comprising a liquid crystal material between a pair of substrates arranged in opposite relation with respect to each other by spacing means

Such display devices are used in, for example portable apparatuses such as laptop computers, notebook computers and cellular telephones.

The spacing means (spacers) determine the cell gap in these displays, the cell gap being the distance between the two substrates. Cell gap uniformity is very important for the proper operation of the display device.

U.S. Pat. No. 5,963,288 describes a liquid crystal display device in which the spacers are obtained by UV-curing of a resin such as an epoxide-acrylate, their place being determined by a lithographic process. In the same manufacturing step the sealing means (seal) enclosing the liquid crystal material is provided, using the same material.

In general said seal however is chosen to be an anisotropically conducting seal to provide contacting between electrodes on the upper substrate to contacting pads on the bottom substrate. In the examples of U.S. Pat. No. 5,963,288 a non-conducting resin is used, preventing the contacting between electrodes on the upper substrate to pads on the bottom substrate. Also a conducting resin could be chosen but this would lead to a full short-circuiting between said electrodes on the upper substrate to pads on the bottom substrate.

Furthermore the requirements for the spacing member material and the sealing member material are quite different. The spacing member material should keep a certain fixed form in order to control the cell gap, whereas the sealing member material is optimized for adhesion to both substrates, properties that are hard to combine in one singe material.

In the examples of U.S. Pat. No. 5,963,288 the spacing material is applied on top of an orientation layer like polyimide, which orients the liquid crystal molecules. In a next step however the spacing material is subject to a photolithographic treatment including development steps with solvents like e.g. acetone, which may destroy the orientating properties of said orientation layer.

It is an objective of the invention to overcome at least one of the problems mentioned above. To this end a method for manufacturing a (display) device according to the invention comprises the steps of

a) applying a partially solidified resinous or polyimide material on to at least a first substrate at the area of the spacing member or sealing member to be formed

b) providing a second substrate on the partially solidified members

c) further solidifying said resinous or polyimide material

In a preferential embodiment the resinous or polyimide material is applied on the substrates at the area of the spacing member or sealing member to be formed before partially solidifying said spacing member material or said sealing member material.

By choosing resinous material at the area of the spacing member or polyimide material at the area of the sealing member, which are partially solidified during one of the processing steps, these remain sticky. These spacers, which are sticky make good contact with the second substrate and control the cell gap when they are solidified in a following step.

The solidifying may be a physical process, a chemical process or both.

Before said assembly of the two substrates an orientation layer may be provided on at least the first substrate, which now is not affected by the photolithographic treatment including development steps with solvents like e.g. acetone

A way to achieve optimum interaction of the spacer material with both substrates is to provide both substrates with a partially solidified resinous or polyimide material at the area of the spacing member or sealing member to be formed and subsequently couple these substrates.

These and other aspects of the invention will now be elucidated with reference to some non-restricting embodiments and the drawing in which

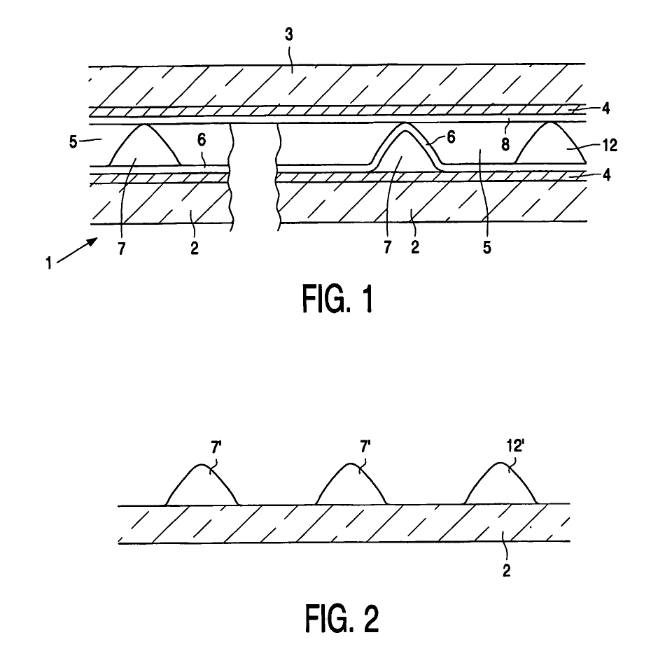

FIG. 1 shows diagrammatically cross-section of a part of a display device, in which the invention is used, while

FIG. 2 shows a part of a display device during manufacturing

The Figures are diagrammatic and not drawn to scale. Corresponding elements are generally denoted by the same reference numerals.

FIG. 1 shows a cross-section of a part of a liquid crystal device 1 having liquid crystal material 5 between a bottom substrate 2 and an upper substrate 3. The liquid crystal device has picture electrodes 4 on the bottom substrate 2 and the other substrate 3. The distance between the substrates is about 0.8-10 micrometer, although for other electro-optical effects (electrophoretic) it may be up to 50 micrometers.

The substrates 2, 3, further comprise orientating layers 6, 8 and if necessary (not shown) color filters. The substrate 2, 3 comprise spacer means 7 which may be covered (right portion of FIG. 1) or not covered (left portion of FIG. 1) with the orientating layer 6. A seal 12 enclosing the liquid crystal material is provided.

The structure shown is obtained by applying onto substrate 2 a resin 7′ such as a novolak, preferably in between the electrodes 4, which is subjected to a photo-lithographical step to define future spacers and a further material 12′ such as an epoxy material or a polyimide which is also subjected to a photo-lithographical step to define a future seal (see FIG. 2). If necessary the two photo-lithographical steps can be combined. On the other hand (not shown in this example) the resin 7′ may be applied on one substrate and the polyimide 12′ on the other substrate.

In a next step the resin 7′ and the polyimide 12′ are only partly solidified. Consequently the upper parts of their structures remain sticky. The lower parts of these structures have developed sufficient stiffness to act as a spacer for the second substrate. This will leave some flexibility, especially near the top.

Then the second substrate 3 is placed onto the first substrate 2 provided with partially solidified structure 7′, 12′, under a certain pressure.

To achieve a proper interaction of at least the upper surface part of the spacer structures on the first substrate with the surface of the second substrate some mobility should remain at the interface of the spacer and the counter substrate. This mobility is likely to be introduced in the spacer structure but might also be present in the top layer of the second substrate (e.g. in a polyimide orientation layer present on the second substrate). There are generally various ways of introducing mobility in the spacer structures.

A first method of introducing mobility in the spacer structures comprises swelling the spacers with a different chemical substance(s) in which the swelling agent typically is a low molecular weight substance such as for instance, a solvent used in the processing of the spacer structures or polyimide orientation layer. The swelling agent promotes the mobility of the spacer molecules by softening the spacer, making it more compressible, elastic and tackifying (making tacky) the surface. The swelling agent might swell both cross-linked and non-cross-linked spacer structures. Cross-linked spacer structures consist of a molecular network structure that is susceptible to swelling agents with a proper compatibility. For instance, polar polymeric networks might be easily swollen with water and apolar polymeric networks might be swollen with heptanes. Non-cross-linked spacers do not posses a chemical network but might still be swollen with a swelling agent. However, to retain the geometrical structure and integrity of the spacer, special care should be taken not to use a swelling agent which dissolves the spacers or to use only very little of this agent. The swelling agent might also be a molecule, which is generally termed as a “gelling agent” or “plastifier” or “tackifier” or “softening agent”. The swelling agent might be present in the processing of the spacers, such as the solvent used in spinning the spacer material, in which case this solvent should not be fully removed (dried) during processing. Alternatively the swelling agent might be added in a separate processing step, such as using spin coating or a vapor flow. After or during coupling of the substrates by applying pressure (optionally by vacuum) the swelling agent is preferably (partially) removed in order to solidify the spacer to achieve a proper mechanical integrity and/or in order not to contaminate the display material (such as the Liquid Crystal). The swelling might occur throughout the spacer or might be inhomogeneous (e.g. swelling near the surface due to limited diffusion of the swelling agent into the spacer).

This type of solidification can be termed “physical solidification” as no chemical reactions occur. However, in principle the swelling agent might also be chemically active such as to be able to react with itself or a spacer component, for instance upon increased temperature. In such a case it might not be necessary to remove this agent as it can be built-into the spacer.

### EXAMPLE 1

### Sticking by Swelling

A novolak resist was spin coated onto a display substrate on a Polyimide alignment layer. The layer was dried to remove the solvent and subsequently illuminated through a mask with ultraviolet (UV)-light. The layer was heated to 90 degrees Celsius for 15 minutes and subsequently cooled down and developed. The resulting spacer pattern was dried and rubbed in order to align the polyimide. Subsequently MMP (methyl methoxy propionate) was spun over the resist layer to swell the spacer pattern. The substrate containing sticky spacers was coupled to a second display substrate (containing an orientation layer at its surface) in a vacuum mold and heated to a temperature of 150 degrees Celsius for 1 hour.

### EXAMPLE 2

### Sticking by Swelling

A novolak resist was spin coated onto a display substrate. The layer was dried to remove the solvent and subsequently illuminated through a mask with Ultra Violet (UV)-light. The layer was heated to 90 degrees Celsius for 15 minutes and subsequently cooled down and developed. The resulting spacer pattern was dried at 150 degrees Celsius for 60 min. Subsequently a Polyimide (PI) precursor was spun over the resist layer. The resulting orientation layer was cured at 150 degrees Celsius for 60 min. and subsequently rubbed. N-methyl pyrrolidone (NMP) was spun on the orientation layer in order to tackify the PI. The substrate containing tackified Polyimide (PI) on a spacer resist structure was coupled to a second display substrate (containing an orientation layer at its surface) in a vacuum mold and heated to a temperature of 150 degrees Celsius for 1 hour.

Another example of “physical solidification” is softening by temperature in which the spacer material might comprise a material, which softens at elevated temperature, such as to achieve high mobility for coupling at an elevated processing temperature but a low mobility with higher mechanical strength at room temperature. A typical example of such a material is an amorphous polymer with a glass transition temperature (Tg) above room temperature. The material is glassy (hard) below Tg but gradually softens near and above Tg (becomes rubbery).

A second method of introducing mobility in the spacer structures comprises limited chemical solidification of the spacer structure.

In photolithographic processes the mask patterning in order to define spacers structures involves chemical reactions. In positive resists this generally involves a light induced chemical reaction of a substance, which promotes the dissolution of a binder (polymeric) material, which results after development in a positive “image” of the mask (spacers present in the non-light transmitting areas). In negative resists the solubility of the resist materials is reduced by inducing a molecular chain growth (polymerization) chemical reaction (monomers are converted to polymers) such as to result in a negative image of the mask (spacers present in the light transmitting areas).

In the latter case the conversion (=amount of monomer converted to polymer) can be used as a means to control the amount of mobility and mechanical strength of the spacer. For instance, conversion=0 (no polymer) will result in high mobility (as the monomers are usually liquid) but no mechanical integrity, whereas conversion=1 (all polymer, no monomer left) will yield a high mechanical strength but low molecular mobility. Therefore a controlled intermediate conversion is preferred prior to cell coupling to combine a sufficient mechanical stiffness with a sufficient molecular mobility for optimal adhesion. For instance, a free-radical type of photopolymerisation might typically result in a conversion of 0.6 at room temperature. The spacer can therefore be regarded as swollen with 40% of monomer in a polymer matrix. The polymer matrix can be either cross-linked or non-cross-linked. After or during coupling the conversion can be increased by increasing the temperature.

Alternatively or in addition to the control over conversion, also the molecular weight (average chain length) of the polymerized material and the distribution of the molecular weight are means to control the spacer mobility, as low molecular weights or the presence of low molecular weight fragments increase the mobility. Again, increasing temperature will result in increased molecular weights and reduced mobilities.

### EXAMPLE 3

### Sticking by Partial Chemical Solidification

An acrylate functionalized polyimide was spin coated onto the display substrate. The layer was dried to remove the solvent and subsequently illuminated at room temperature through a mask with ultraviolet radiation (UV-light). The layer was developed to achieve the spacer pattern and subsequently dried. The substrate containing sticky spacers is coupled to the second display substrate by applying pressure at elevated temperature.

Yet another example (“limited surface solidification”) originates in oxygen inhibition of the photochemical reaction, in which e.g. a solution containing an acrylate-photo-resist is spin coated onto the display substrate. Subsequently the layer is dried to remove the solvent. The layer is illuminated through a mask with Ultra Violet (UV)-light in the presence of air and subsequently developed in the solvent. The oxygen present during the illumination step inhibits the reaction on the surface of the material. The resulting resist pattern is dried to remove the developer. The substrate containing sticky spacers is coupled to the second display substrate by applying pressure at elevated temperature.

The invention is not restricted to the examples shown. For instance the orientating layer 6 may be applied on substrate 2 after partially solidifying the structures 7′, 12″, leading to the structure at the right hand side of FIG. 1.

Also both substrates may be provided with sticky spacers. In example 2 the second display substrate may contain a sticky orientation layer at its surface; in this latter case the spacers at the first surface may be completely solidified, the spacing being defined by the further solidifying of said orientation layer and applying pressure.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A method for manufacturing a device (1) in which a spacing member (7) or a sealing member (12) between two substrates (2,3) is obtained by
a) applying a partially solidified resinous or polyimide material on to at least a first substrate (2) at the area of the spacing member or sealing member to be formed
b) providing a second substrate (3) on the partially solidified members
c) further solidifying said resinous or said polyimide material

2. A method for manufacturing a device (1) as claimed in claim 1 in which the partially solidified resinous or polyimide material is obtained by
applying resinous or polyimide material on to at least a first substrate (2) at the area of the spacing member or sealing member to be formed and then partially solidifying said spacing member material or said sealing member material and providing said members with a tacky surface.

3. A method according to claim 1 in which the step of applying a partially solidified resinous or polyimide material comprises the introduction of a swelling agent

4. A method according to claim 3 in which material for a functional layer of the display device is introduced before the introduction of a swelling agent or together with a swelling agent.

5. A method according to claim 1 in which the resinous or polyimide material is applied by means of an ink-jet system.

6. A method according to claim 1 in which spacing members and sealing members are applied in different process steps.

7. A method according to claim 1, the substrates being flexible.

8. A method according to claim 1, the distance between the substrates being 0.8 to 50 μm.

9. A method according to claim 1 in which both substrates are provided with a partially solidified resinous or polyimide material at the area of the spacing member or sealing member to be formed.

10. A method for manufacturing a device (1) as claimed in claim 1 in which the partially solidified resinous or polyimide material is applied to the second substrate (3) at least at the area of the spacing member or sealing member to be formed.

11. A method according to claim 1 in which the device is a display device.

12. A display device (1) comprising a liquid crystal material (5) between a pair of substrates (2, 3) arranged in opposite relation with respect to each other by spacing means (7), at least one of the substrates being provided with an orientation layer (6) the orientation layer covering the spacer means.
